(19) United States
(12) Patent Application Publication
(10) Pub. No.: US 2026/0167037 A1
(43) Pub. Date: Jun. 18, 2026

(54) CHARGING SYSTEM FOR AN ELECTRIFIED VEHICLE AND CONTROL METHOD THEREOF

(71) Applicants: Hyundai Motor Company, Seoul (KR); Kia Corporation, Seoul (KR)

(72) Inventors: Sin Young YOO, Hwaseong-si (KR); Jun Hyuk LEE, Hwaseong-si (KR); Sang Yoo LEE, Hwaseong-si (KR); Jang Yoon JEONG, Hwaseong-si (KR)

(73) Assignees: Hyundai Motor Company, Seoul (KR); Kia Corporation, Seoul (KR)

(21) Appl. No.: 19/405,778

(22) Filed: Dec. 2, 2025

(30) Foreign Application Priority Data
Dec. 13, 2024 (KR) 10-2024-0186146

(51) Int. Cl. B60L 53/60; B60L 53/30; H02J 7/14; H02M 7/483; H02M 7/5395

(52) U.S. Cl. CPC B60L 53/60; B60L 53/30; H02J 7/14; H02M 7/483; H02M 7/5395

(57) ABSTRACT

In a charging system for a vehicle and a control method thereof, the charging system includes a controller configured to control duty cycles of a plurality of switching elements included in an inverter based on a duty command that causes a voltage of a neutral point to follow a predetermined neutral point voltage command in case of charging current from an external power source being provided to the neutral point of a motor, and compensate the duty command based on a voltage signal extracted from the voltage of the neutral point and included in a predetermined frequency band.

### CROSS-REFERENCE TO RELATED APPLICATION

The present application claims priority from Korean Patent Application No. 10-2024-0186146 filed on Dec. 13, 2024, in the Korean Intellectual Property Office, the present disclosure of which is incorporated herein by reference in its entirety.

### BACKGROUND OF THE PRESENT DISCLOSURE

### Field of the Present Disclosure

The present disclosure relates to a charging system for an electrified vehicle and a control method thereof configured for reducing neutral point voltage resonance of a motor during battery charging using a motor and an inverter.

### Description of Related Art

Generally, electric vehicles or plug-in hybrid vehicles convert power provided from external charging equipment into a state suitable for in-vehicle battery charging and provide it to the battery to conduct battery charging.

For example, conventional charging equipment for dc fast charging was manufactured to output a single voltage specification of 400V, but batteries used in vehicles are designed to have a voltage of 800V or higher for improving efficiency and driving range. Therefore, dc fast charging equipment still provides a charging voltage of 400V, but batteries used in vehicles have voltage specifications of 800V or higher, so a boost converter is required to step up the voltage provided from external charging equipment for battery charging.

However, a large-capacity boost converter for stepping up 400V voltage to 800V or higher is not only very large in weight and volume but also expensive, making it difficult to equip in vehicles and may cause an increase in vehicle cost.

Accordingly, there is a demand in the field of the present disclosure for new charging technology that can receive voltage from charging equipment providing relatively low charging voltage built as existing infrastructure and step up to high voltage without additional devices and additional cost increases to provide to the battery.

The matters described as the above background technology are only for enhancing understanding of the background of the present disclosure, and should not be accepted as acknowledging that they correspond to related art already known to those having ordinary knowledge in the field of the present disclosure.

### BRIEF SUMMARY

The object of the present disclosure is to provide a charging system for a vehicle and a control method thereof configured for reducing neutral point voltage resonance of a motor during battery charging using a motor and an inverter.

The problems of the present disclosure are not limited to the problems mentioned above, and other problems not mentioned will be clearly understood by those skilled in the art from the description below.

According to various aspects of the present disclosure, a charging system for a vehicle includes a motor having multiple windings respectively corresponding to a plurality of phases; an inverter having multiple legs respectively connected to one ends of the multiple windings and each having multiple switching elements connected thereto, and a dc link; a battery connected to the dc link; a neutral point capacitor connected to a neutral point of the motor formed by interconnecting other ends of the multiple windings; and a controller configured to control duty cycles of the multiple switching elements based on a duty command that causes a voltage of the neutral point to follow a predetermined neutral point voltage command in case of charging current from an external power source being provided to the neutral point of the motor, and compensate the duty command based on a voltage signal extracted from the voltage of the neutral point and included in a predetermined frequency band.

According to various aspects of the present disclosure, a control method for a charging system for a vehicle is a method for controlling a charging system for a vehicle including a motor having multiple windings respectively corresponding to a plurality of phases, an inverter having multiple legs respectively connected to one ends of the multiple windings and each having multiple switching elements connected thereto and a dc link, a battery connected to the de link, and a neutral point capacitor connected to a neutral point of the motor formed by interconnecting other ends of the multiple windings, the method including controlling duty cycles of the multiple switching elements based on a duty command that causes a voltage of the neutral point to follow a predetermined neutral point voltage command in case of charging current from an external power source being provided to the neutral point of the motor; and compensating the duty command based on a voltage signal extracted from the voltage of the neutral point and included in a predetermined frequency band.

According to various aspects of the present disclosure, when battery voltage is higher than supply voltage of external charging equipment through voltage boosting using a motor and an inverter, it becomes possible to charge the battery without adding a separate boost converter.

According to various aspects of the present disclosure, it becomes possible to stably charge the battery by reducing resonance due to current disturbance of external charger current occurring during the battery charging process, and alleviate durability damage of the motor and inverter during the charging process.

The effects obtainable from the present disclosure are not limited to the effects mentioned above, and other effects not mentioned will be clearly understood by those having ordinary knowledge in the field of the present disclosure to which the present disclosure belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing a configuration of a charging system for an electrified vehicle according to an exemplary embodiment of the present disclosure;

FIG. 2 is a diagram showing a zero-sequence voltage equivalent model of a charging system according to an exemplary embodiment of the present disclosure;

FIG. 3 is a diagram for explaining a controller structure of a charging system according to an exemplary embodiment of the present disclosure;

FIG. 4 is a diagram for explaining a compensation process of a duty command according to an exemplary embodiment of the present disclosure; and

FIG. 5 is a flowchart for explaining a control method of a charging system according to an exemplary embodiment of the present disclosure.

### DETAILED DESCRIPTION

The specific structural or functional descriptions of the embodiments of the present disclosure disclosed in the present specification or application are only illustrated for the purpose of describing embodiments according to an exemplary embodiment of the present disclosure, and exemplary embodiments of the present disclosure may be implemented in various forms and should not be interpreted as being limited to the embodiments described in the present specification or application.

Since exemplary embodiments of the present disclosure can be modified in various ways and can have various forms, specific embodiments are illustrated in the drawings and will be described in detail in the present specification or application. However, this is not intended to limit embodiments according to the concept of the present disclosure to specific disclosed forms, and should be understood to include all changes, equivalents, and substitutes included in the spirit and technical scope of the present disclosure.

Unless defined otherwise, all terms used herein, including technical or scientific terms, have the same meaning as commonly understood by those having ordinary knowledge in the field of the present disclosure to which the present disclosure relates. Terms such as those defined in commonly used dictionaries should be interpreted as having meanings consistent with meanings they have in the context of related art, and unless explicitly defined in the present specification, they are not interpreted as having ideal or excessively formal meanings.

Hereinafter, various exemplary embodiments disclosed in the present specification will be described in detail with reference to the accompanying drawings, but identical or similar components are given the same reference numbers regardless of drawing symbols, and redundant descriptions thereof will be omitted.

In the description of the following embodiments, the term “predetermined” means that the numerical value of a parameter is determined in advance when the parameter is used in a process or algorithm. The numerical value of the parameter may be set when the process or algorithm starts or may be set during the period when the process or algorithm is performed, depending on the embodiment.

The suffixes “module” and “unit” for components used in the following description are given or mixed only considering the ease of specification writing, and do not have meanings or roles that are distinguished from each other by themselves.

In describing the embodiments disclosed in the present specification, when it is determined that specific descriptions of related known technologies may obscure the gist of the embodiments disclosed in the present specification, detailed descriptions thereof are omitted. In addition, the appended drawings are only for easy understanding of the embodiments disclosed in the present specification, and the technical ideas disclosed in the present specification are not limited by the appended drawings, and should be understood to include all changes, equivalents, and substitutes included in the spirit and technical scope of the present disclosure.

Terms including ordinal numbers such as first and second may be used to describe various components, but the components are not limited by the terms. The terms are used only for the purpose of distinguishing one component from another component.

When it is mentioned that a component is “connected” or “connected” to another component, it should be understood that it may be directly connected or connected to the other component, but other components may exist in between. On the other hand, when it is mentioned that a component is “directly connected” or “directly connected” to another component, it should be understood that no other components exist in between.

Singular expressions include plural expressions unless the context clearly indicates otherwise.

In the present specification, terms such as “include” or “have” are intended to designate that features, numbers, steps, operations, components, parts, or combinations thereof described in the specification exist, and should be understood as not excluding in advance the existence or possibility of addition of one or more other features, numbers, steps, operations, components, parts, or combinations thereof.

Furthermore, Unit or Control Unit included in names such as Motor Control Unit (MCU) and Hybrid Control Unit (HCU) are only terms widely used in naming controllers that control vehicle-specific functions, and do not mean generic function units.

Hereinafter, before describing the control method of the charging system according to an exemplary embodiment of the present disclosure, the charging system for an electrified vehicle according to an exemplary embodiment will be described first.

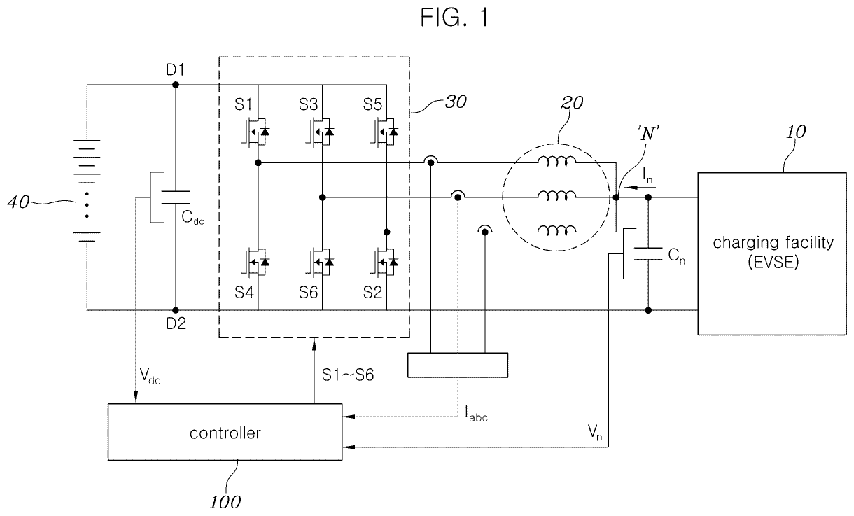

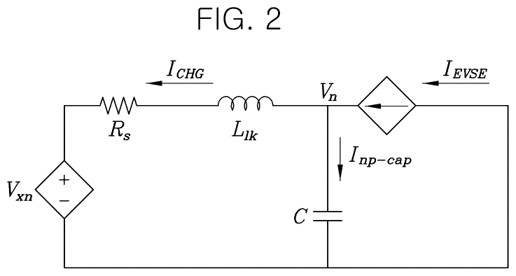

FIG. 1 is a diagram showing a configuration of a charging system for an electrified vehicle according to an exemplary embodiment of the present disclosure, and FIG. 2 is a diagram showing a zero-sequence voltage equivalent model of a charging system according to an exemplary embodiment of the present disclosure.

First, referring to FIG. 1, the charging system according to an exemplary embodiment of the present disclosure includes motor 20, inverter 30, battery 40, neutral point capacitor Cₙ, de link capacitor C_{dc}, and controller 100, and can charge battery 40 through motor 20 and inverter 30. However, FIG. 1 shows mainly components related to the description of an exemplary embodiment of the present disclosure, and the actual charging system may be implemented including more or fewer components than this.

Generally, a system for driving motor 20 may include battery 40, which is an energy storage device that stores power for driving motor 20, and inverter 30 that converts dc power stored in battery 40 into three-phase ac and provides it to motor 20.

Inverter 30 is connected to one end of motor 20 including a plurality of windings respectively corresponding to a plurality of phases, and is connected to battery 40 through dc link D₁, D₂. Inverter 30 includes a plurality of legs S₁-S₄, S₃-S₆, S₅-S₂, and in each leg S₁-S₄, S₃-S₆, S₅-S₂, a plurality of switching elements (two of S₁, S₂, S₃, S₄, S₅ and S₆) are connected in series with each other, and one-phase driving power is provided to motor 20 from the connection node of the plurality of switching elements. Accordingly, the energy flow for driving motor 20 is made in the direction from battery 40 to motor 20 in FIG. 1.

Therefore, one of the plurality of windings of motor 20 and switching elements S₁, S₂, S₃, S₄, S₅ and S₆ in legs S₁-S₄, S₃-S₆, S₅-S₂ of inverter 30 connected thereto can form one boost circuit. In other words, a circuit equivalent to boost circuits corresponding to each phase being connected in parallel between neutral point N of motor 20 and battery 40 can be configured by motor 20 and inverter 30.

Embodiments of the present disclosure, unlike the energy flow for motor driving described above, receive external charging power provided from external power source 10 including charging equipment such as Electric Vehicle Supply Equipment (EVSE) to neutral point N of motor 20 through legs S₁-S₄, S₃-S₆, S₅-S₂ corresponding to each phase of inverter 30, control switching elements S₁, S₂, S₃, S₄, S₅ and S₆ of each leg S₁-S₄, S₃-S₆, S₅-S₂ to boost and then provide to battery 40 to enable charging of battery 40.

That is, in various embodiments of the present disclosure, the motor 20 side connection terminal of inverter 30 becomes the input terminal of inverter 30, and the battery 40 side connection terminal of inverter 30 can become the output terminal of inverter 30.

The charging system according to an exemplary embodiment of the present disclosure may include motor 20 including a plurality of windings respectively corresponding to a plurality of phases, inverter 30 including a plurality of legs S₁-S₄, S₃-S₆, S₅-S₂ connected to one end of each of the plurality of windings and each including a plurality of switching elements S₁, S₂, S₃, S₄, S₅ and S₆ connected thereto and de link D₁, D₂, battery 40 connected to dc link D₁, D₂, neutral point capacitor Cₙ connected to neutral point N of motor 20 formed by interconnecting the other ends of the plurality of windings, and controller 100.

Accordingly, when charging battery 40 by receiving charging power to neutral point N of motor 20, if voltage Vₙ of neutral point N, which becomes the input terminal during charging, is not properly controlled, charging may be interrupted or, in serious cases, may cause damage to the system, so neutral point voltage Vₙ of motor 20 needs to be stably controlled.

Therefore, controller 100 according to an exemplary embodiment can stably control voltage Vₙ of neutral point N by controlling the duty cycles of a plurality of switching elements S₁, S₂, S₃, S₄, S₅ and S₆ based on a duty command that causes voltage Vₙ of neutral point N to follow a predetermined neutral point voltage command when charging current from external power source 10 is provided to neutral point N of motor 20, that is, when charging battery 40 by boosting the voltage of external power source 10 through motor 20 and inverter 30.

Also, referring to FIG. 2, the zero-sequence voltage equivalent model of the charging system according to an exemplary embodiment can be expressed through output voltage Vₓₙ of the voltage control unit that controls the voltage of neutral point N, stator resistance Rₛ of motor 20, leakage inductance Lₗₖ of motor 20, and capacitance C of neutral point capacitor Cₙ. In the instant case, the impedance component viewed from the external power source side has very small characteristics in a specific frequency band, and accordingly, when current disturbance including a component of a specific frequency is input, neutral point voltage Vₙ can cause resonance with that frequency. If resonance in neutral point voltage Vₙ is not rapidly attenuated accordingly, it can affect the durability of the charging system and charging can be interrupted. Here, current disturbance is included in current I_{EVSE} input from EVSE and flows into the vehicle side. Therefore, current disturbance components are also included in charging current (here, I_{CHG}) that branches from the neutral point and flows to the motor and neutral point capacitor current I_{np-cap} that flows to neutral point capacitor Cₙ, respectively, and affects the neutral point voltage while passing through impedance components Lₗₖ, C on the path.

Accordingly, controller 100 according to an exemplary embodiment proposes to improve charging stability by suppressing resonance due to current disturbance of external power source 10 by compensating the duty command based on a voltage signal extracted from voltage Vₙ of neutral point N and included in a predetermined frequency band.

Meanwhile, external power source 10 such as EVSE can operate in current control mode or voltage control mode, so it is also possible to implement so that neutral point voltage Vₙ of motor 20, which becomes the input terminal of charging power, is controlled on the external power source side, but since external power source 10 side often operates in current control mode in general charging situations, various exemplary embodiments of the present disclosure can be implemented in a manner in which controller 100 performs control of neutral point voltage Vₙ and current control is performed on external power source 10 side.

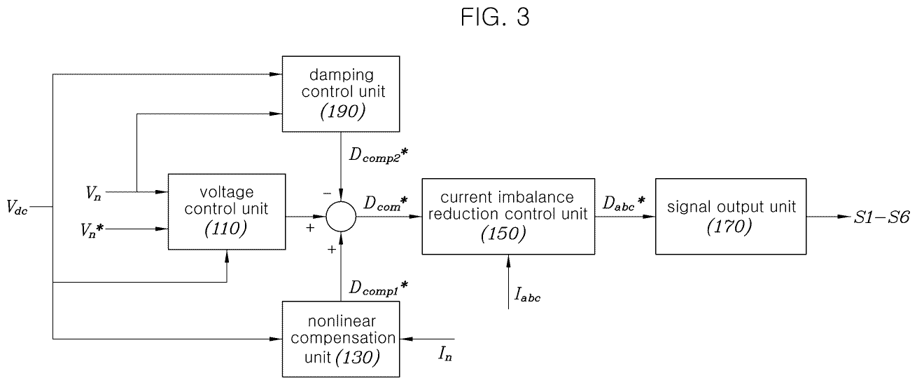

Hereinafter, the charging control method through the controller according to an exemplary embodiment will be described in more detail with reference to FIG. 3.

FIG. 3 is a diagram for explaining a controller structure of a charging system according to an exemplary embodiment of the present disclosure.

Referring to FIG. 3, controller 100 of the charging system according to various exemplary embodiments of the present disclosure may include voltage control unit 110, nonlinear compensation unit 130, current imbalance reduction control unit 150, signal output unit 170, and damping control unit 190, and may include a communication device that communicates with other controllers or sensors for control of the functions in charge, a memory that stores operating systems or logic instructions and input/output information, and one or more processors that perform judgments, calculations, decisions, etc. necessary for controlling the functions in charge. However, FIG. 3 shows mainly components related to the description of an exemplary embodiment of the present disclosure, and actual controller 100 may be implemented including more or fewer components than this.

First, voltage control unit 110 can generate a duty command that causes voltage Vₙ of neutral point N to follow a predetermined voltage command

$${V}_{n}^{*}$$

when charging current from external power source 10 is provided to neutral point N of motor 20, and through this, voltage Vₙ of neutral point N can be constantly controlled to neutral point voltage command

$${V}_{n}^{*} .$$

Nonlinear compensation unit 130 can generate compensation duty

$${D}_{comp 1}^{*}$$

for compensating nonlinearity of inverter 30 based on current Iₙ of neutral point N and voltage V_{dc} of dc link D₁, D₂. Here, nonlinearity of inverter 30 means the difference between input/output caused by dead time of switching elements S₁, S₂, S₃, S₄, S₅ and S₆ for safe driving of inverter 30, on/off delay time of inverter 30 driving circuit, characteristics of switching elements S₁, S₂, S₃, S₄, S₅ and S₆ themselves, etc. Such nonlinearity of inverter 30 can cause differences between duty determined by the control algorithm and voltage of inverter 30 and duty and inverter voltage actually output, and accordingly can cause control error, reduction of dynamic characteristics, etc. Therefore, in an exemplary embodiment of the present disclosure, by compensating the duty command generated by voltage control unit 110 through compensation duty D*_{comp1} generated by nonlinear compensation unit 130, nonlinearity of inverter 30 can be compensated during the charging process of battery 40.

Current imbalance reduction control unit 150 can generate a duty command that individually controls the duty cycles of a plurality of switching elements S₁, S₂, S₃, S₄, S₅ and S₆ connected to each of a plurality of legs S₁-S₄, S₃-S₆, S₅-S₂ based on compensated duty command

$${D}_{c o m}^{*}$$

and phase current I_{abc} flowing through each of the plurality of windings of motor 20. In the instant case, compensated duty command

$${D}_{com}^{*}$$

is duty commonly applied to a plurality of boost circuits corresponding to each phase of motor 20 and inverter 30.

Current imbalance reduction control unit 150 can generate duty command

$${D}_{abc}^{*}$$

that individually controls the duty cycles of a plurality of switching elements S₁, S₂, S₃, S₄, S₅ and S₆ based on compensated duty command

$${D}_{com}^{*}$$

and phase currents I_{abc} flowing through each of the plurality of windings of motor 20 to eliminate imbalance of boost circuits corresponding to each phase.

Current imbalance reduction control unit 150 can control duty cycles for switching elements S₁, S₂, S₃, S₄, S₅ and S₆ forming each boost circuit so that phase currents flowing through each of the plurality of windings of motor 20 follow the average value of phase currents.

Accordingly, current of the same magnitude flows in boost circuits corresponding to each phase, eliminating imbalance of motor 20 and inverter 30, and preventing torque from being generated in motor 20 during charging due to imbalance of each phase.

Signal output unit 170 can generate and output driving signals corresponding to individual duty commands

$${D}_{abc}^{*}$$

generated by current invariance reduction control unit 150, and can perform pulse width modulation for the present purpose. Signal output unit 170 can control the duty cycles of switching elements through driving signals generated through pulse width modulation that causes a plurality of legs S₁-S₄, S₃-S₆, S₅-S₂ to be sequentially turned on and turned off to increase charging efficiency in a process of charging battery 40 by boosting the voltage of external power source through motor 20 and inverter 30. In the instant case, turn-on of a leg can mean a state in which top switching elements S₁, S₃, S₅ respectively connected to each leg S₁-S₄, S₃-S₆, S₅-S₂ are turned on and bottom switching elements S₂, S₄, S₆ are turned off, and turn-off of a leg can mean the opposite case.

The pulse width modulation method that causes a plurality of legs S₁-S₄, S₃-S₆, S₅-S₂ to be sequentially turned on and turned off can be expressed as an interleaved pulse width modulation method, and according to such an interleaved pulse width modulation method, dq-axis voltage ripple exists but zero-sequence voltage ripple can be reduced. In the instant case, since dq-axis inductance is greater than zero-sequence inductance, it does not greatly affect phase current ripple, and during charging, only zero-sequence current conducts to neutral point capacitor Cₙ, so dq-axis voltage and current ripple do not affect the capacitance of neutral point capacitor Cₙ, enabling reduction of current ripple, and accordingly, iron loss of motor 20 during charging can be reduced and charging efficiency can be improved.

Meanwhile, controller 100 according to various exemplary embodiments of the present disclosure may further include damping control unit 190 for suppressing resonance due to current disturbance on external power source 10 side, in addition to the above-described voltage control unit 110, nonlinear compensation unit 130, current imbalance reduction control unit 150, and signal output unit 170.

Damping control unit 190 can generate compensation duty

$${D}_{comp 2}^{*}$$

based on neutral point voltage Vₙ and voltage V_{dc} of dc link D₁, D₂, and by compensating the duty command with generated compensation duty

$${D}_{comp 2}^{*} ,$$

resonance due to current disturbance can be rapidly attenuated.

Such compensation of duty command can be performed while charging current from external power source is provided to neutral point N, that is, during boost charging, and furthermore, can be performed after initial charging is completed when the voltage of neutral point capacitor Cₙ reaches the voltage of external power source.

In contrast, in a charging form in which the voltage of external power source 10 is directly applied to battery 40, there is no need to control the voltage of neutral point N for voltage boosting, so compensation of duty command may not be performed.

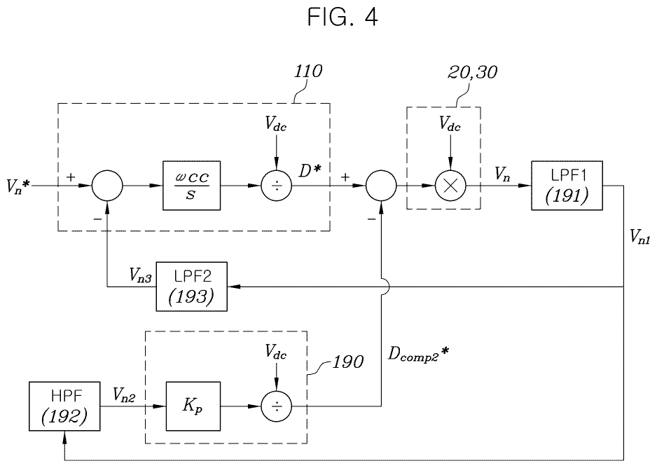

The duty compensation process for such resonance suppression will be described in detail below with reference to FIG. 4.

FIG. 4 is a diagram for explaining a compensation process of a duty command according to an exemplary embodiment of the present disclosure.

Referring to FIG. 4, voltage control and damping control processes during the boost charging process are shown.

First, damping control unit 190 is configured to determine compensation duty

$${D}_{comp 2}^{*}$$

based on a voltage signal extracted from voltage Vₙ of the neutral point and included in a predetermined frequency band, and for the present purpose, can obtain voltage signal Vₙ₂ included in the predetermined frequency band and voltage V_{dc} of dc link D₁, D₂.

Controller 100 may include first low-pass filter 191 and high-pass filter 192, and first low-pass filter 191 and high-pass filter 192 can extract ripple components from voltage Vₙ of neutral point N.

First, first low-pass filter 191 obtains voltage Vₙ of neutral point N as an input signal and can output first voltage signal Vₙ₁ having a frequency less than a predetermined first cutoff frequency among the input signal. In the instant case, voltage Vₙ of neutral point N can be obtained through a voltage sensor connected to both ends of neutral point capacitor Cₙ.

The first cutoff frequency may include, for example, 10 kHz to sufficiently detect ripple components while minimizing noise of neutral point voltage Vₙ. Also, the first low-pass filter can be implemented as a hardware filter in which the first cutoff frequency is set through an analog circuit, and through this, can have high processing speed in primarily filtering voltage Vₙ of neutral point N.

Also, controller 100 may further include high-pass filter 192 that obtains first voltage signal Vₙ₁ as an input signal and outputs second voltage signal Vₙ₂ including a frequency exceeding a second cutoff frequency including a value less than the first cutoff frequency among first voltage signal Vₙ₁. High-pass filter 192 can suppress signals including frequencies less than the second cutoff frequency among first voltage signal Vₙ₁ that primarily passed through first low-pass filter 191, and output second voltage signal Vₙ₂ including frequencies exceeding the second cutoff frequency.

In the instant case, the second cutoff frequency may include 0 Hz to delete dc components from voltage Vₙ of neutral point N, and second voltage signal Vₙ₂ that passed through first low-pass filter 191 and high-pass filter 192 includes ripple components including values between the first cutoff frequency and the second cutoff frequency. Therefore, damping control unit 190 can generate compensation duty D_{comp2} for resonance suppression based on second voltage signal Vₙ₂ included in the band between the first cutoff frequency and the second cutoff frequency as such.

Meanwhile, the high-pass filter can be implemented as a software filter in which the second cutoff frequency is set through a software algorithm, unlike the first low-pass filter, and through this, dc components can be removed by precisely setting the cutoff frequency. Also, through the combination of first low-pass filter 191, which is a hardware filter, and high-pass filter, which is a software filter, voltage signals exceeding the first cutoff frequency are rapidly removed through first low-pass filter 191 to reduce the computational load of high-pass filter 192, and high-pass filter 192 filters only first voltage signal Vₙ₁ that was primarily filtered instead of filtering the entire neutral point voltage Vₙ, enabling securing both speed and accuracy of frequency component extraction.

Furthermore, when compensating duty command D* based on neutral point N voltage Vₙ, that is, second voltage signal Vₙ₂, that passed through first low-pass filter 191 and high-pass filter accordingly, errors due to offset can be reduced compared to the method of obtaining ripple components by reflecting neutral point voltage command

$${V}_{n}^{*}$$

in calculation, and only the frequency part that becomes the target of resonance can be effectively utilized as control input values.

Damping control unit 190 generates compensation duty

$${D}_{comp 2}^{*}$$

based on second voltage signal Vₙ₂ that passed through first low-pass filter 191 and high-pass filter 192 and voltage V_{dc} of dc link D₁, D₂, and compensation duty

$${D}_{comp 2}^{*}$$

is subtracted from duty command D* so that duty command D* is compensated.

For the present purpose, damping control unit 190 can apply proportional gain Kₚ to second voltage signal Vₙ₂, and can generate compensation duty

$${D}_{comp 2}^{*}$$

by dividing second voltage signal Vₙ₂ to which proportional gain Kₚ is applied by voltage V_{dc} of dc link D₁, D₂.

Meanwhile, voltage control unit 110 can generate duty command D* based on an error between neutral point voltage command

$${V}_{n}^{*}$$

and first voltage signal Vₙ₁, and through this, can generate duty command D* that causes neutral point voltage Vₙ to follow neutral point voltage command

$${V}_{n}^{*} .$$

Also, controller 100 may further include second low-pass filter 193 that obtains first voltage signal Vₙ₁ as an input signal and outputs third voltage signal Vₙ₃ including a frequency less than a third cutoff frequency including a value (for example, 100 Hz) less than the first cutoff frequency and exceeding the second cutoff frequency among first voltage signal Vₙ₁, and in the instant case, voltage control unit 110 can generate duty command D* based on an error between neutral point voltage command

$${V}_{n}^{*}$$

and third voltage signal Vₙ₃. In an exemplary embodiment of the present disclosure, second low-pass filter 193 can be implemented as a software filter in which the third cutoff frequency is set by a software algorithm, unlike first low-pass filter 191. Through this, the cutoff frequency can be precisely set.

Also, through the combination of first low-pass filter 191, which is a hardware filter, and second low-pass filter 193, which is a software filter, voltage signals exceeding the first cutoff frequency are rapidly removed through first low-pass filter 191 to reduce the computational load of second low-pass filter 193, and second low-pass filter 193 filters only first voltage signal Vₙ₁ that was primarily filtered instead of filtering the entire neutral point voltage Vₙ, enabling securing both speed and accuracy of frequency component extraction.

Third voltage signal Vₙ₃ that passed through the second low-pass filter can be input to voltage control unit 110 and utilized for voltage control of neutral point N, and in the instant case, voltage control unit 110 can generate duty command D* based on an error between neutral point voltage command

$${V}_{n}^{*}$$

and third voltage signal Vₙ₃.

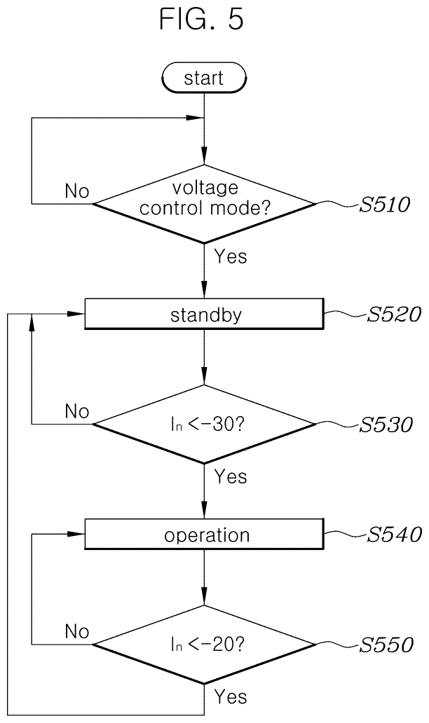

Hereinafter, the control process of the charging system described so far will be described with reference to FIG. 5.

FIG. 5 is a flowchart for explaining a control method of a charging system according to an exemplary embodiment of the present disclosure.

First, controller 100 can determine whether voltage control mode is being performed in step S510. Here, voltage control mode is a mode for controlling the voltage of neutral point N to charge by receiving charging current from external power source through neutral point N, and whether it is performed can be determined through, for example, voltage Vₙ of neutral point N.

Controller 100 can operate and compensate the duty command when neutral point current Iₙ injected from neutral point N to the motor is less than a predetermined first reference current value (for example, −30 A) in step S540 (Yes in S530).

Meanwhile, during compensation of the duty command, if neutral point current Iₙ exceeds a second reference current value (for example, −20 A) that exceeds the first reference current value (Yes in S550), controller 100 can stop compensation of the duty command and wait until neutral point current Iₙ becomes less than the predetermined first reference current value in step S520. Conversely, if neutral point current Iₙ does not exceed the second reference current value (No in S550), controller 100 can continue compensation of the duty command considering that resonance suppression is not completed in step S540.

In the above description, the first reference value and second reference value of neutral point current were exemplified as negative numbers. It should be noted that this is because the inverter side senses current flowing from the motor to the neutral point side as positive, but during charging, current enters from the neutral point to the motor side, so neutral point current is viewed as negative. Therefore, if charging current flowing from the neutral point to the motor side during charging is viewed as positive from a different perspective, the excess/less than perspective in comparison with reference values in the above description should be viewed in reverse.

Meanwhile, in the above embodiment, whether to start and stop compensation was determined through comparison of neutral point current with the first reference value and second reference value. Alternatively, according to other implementations, constant compensation may be performed regardless of reference values.

According to various embodiments of the present disclosure as described above, when battery voltage is higher than supply voltage of external charging equipment through voltage boosting using a motor and an inverter, it becomes possible to charge the battery without adding a separate boost converter.

Furthermore, it becomes possible to stably charge the battery by reducing resonance due to current disturbance of external charger current occurring during the battery charging process, and alleviate durability damage of the motor and inverter during the charging process.

Although shown and described in relation to specific embodiments of the present disclosure as described above, it will be apparent to those including ordinary knowledge in the art that the present disclosure can be variously improved and changed within the scope not departing from the technical spirit of the present disclosure disposed by the following claims.

What is claimed is:

1. A charging system for a vehicle, the charging system comprising:
a motor including a plurality of windings respectively corresponding to a plurality of phases;
an inverter including a plurality of legs respectively connected to first ends of the plurality of windings and each including a plurality of switching elements connected thereto, and a dc link;
a battery connected to the dc link;
a neutral point capacitor connected to a neutral point of the motor formed by interconnecting second ends of the plurality of windings; and
a controller:
controls a duty of the plurality of switching elements based on a duty command that causes a voltage of the neutral point to follow a predetermined neutral point voltage command in a state where a charging current from an external power source is provided to the neutral point of the motor; and
compensates the duty command based on a voltage signal extracted from the voltage of the neutral point and included in a predetermined frequency band.

2. The charging system of claim 1, wherein the controller comprises:
a first low-pass filter obtaining the voltage of the neutral point as an input signal thereof and outputting a first voltage signal including a frequency less than a predetermined first cutoff frequency among the input signal.

3. The charging system of claim 2, wherein the first cutoff frequency includes 10 kHz.

4. The charging system of claim 2, wherein the first cutoff frequency is set through an analog circuit.

5. The charging system of claim 2, wherein the controller further comprises:
a high-pass filter obtaining the first voltage signal as an input signal thereof and outputting a second voltage signal including a frequency exceeding a second cutoff frequency including a value less than the first cutoff frequency among the first voltage signal.

6. The charging system of claim 5, wherein the second cutoff frequency includes 0 Hz.

7. The charging system of claim 5, wherein the second cutoff frequency is set through a software algorithm.

8. The charging system of claim 5, wherein the controller compensates the duty command based on the second voltage signal and a voltage of the de link.

9. The charging system of claim 8, wherein the controller generates the duty command based on an error between the neutral point voltage command and the first voltage signal.

10. The charging system of claim 9,
wherein the controller further comprises a second low-pass filter obtaining the first voltage signal as an input signal thereof and outputting a third voltage signal including a frequency less than a third cutoff frequency including a value less than the first cutoff frequency and exceeding the second cutoff frequency among the first voltage signal, and
wherein the controller generates the duty command based on an error between the neutral point voltage command and the third voltage signal.

11. The charging system of claim 10, wherein the third cutoff frequency is set by a software algorithm.

12. The charging system of claim 1, wherein the controller compensates the duty command based on the voltage signal extracted from the voltage of the neutral point after a voltage of the neutral point capacitor reaches a voltage of the external power source and included in the predetermined frequency band.

13. The charging system of claim 1, wherein the controller compensates the duty command based on the voltage signal extracted from the voltage of the neutral point and included in the predetermined frequency band, based on a value of a current flowing from the neutral point to the motor being less than a predetermined first reference current value.

14. The charging system of claim 13, wherein the controller stops the compensating of the duty command based on the voltage signal extracted from the voltage of the neutral point and included in the predetermined frequency band, based on a value of a current flowing to the neutral point capacitor exceeding a predetermined second reference current value that exceeds the first reference current value.

15. The charging system of claim 1, wherein the controller compensates the duty command based on a voltage of the dc link and a current of the neutral point.

16. The charging system of claim 1, wherein the controller individually controls the duty of the plurality of switching elements connected to each of the plurality of legs based on the duty command and phase currents flowing through each of the plurality of windings.

17. The charging system of claim 1, wherein the controller controls the duty of the plurality of switching elements through pulse width modulation that causes the plurality of legs to be sequentially turned on and turned off.

18. A method for controlling a charging system for a vehicle including a motor including a plurality of windings respectively corresponding to a plurality of phases, an inverter including a plurality of legs respectively connected to first ends of the plurality of windings and each including a plurality of switching elements connected thereto and a dc link, a battery connected to the dc link, and a neutral point capacitor connected to a neutral point of the motor formed by interconnecting second ends of the plurality of windings, the method comprising:
controlling, by a controller, a duty of the plurality of switching elements based on a duty command that causes a voltage of the neutral point to follow a predetermined neutral point voltage command in a state where a charging current from an external power source is provided to the neutral point of the motor; and
compensating, by the controller, the duty command based on a voltage signal extracted from the voltage of the neutral point and included in a predetermined frequency band.

19. The method of claim 18, wherein the compensating includes compensating the duty command based on the voltage signal extracted from the voltage of the neutral point after a voltage of the neutral point capacitor reaches a voltage of the external power source and included in the predetermined frequency band.

20. The method of claim 18, wherein the compensating includes compensating the duty command based on the voltage signal extracted from the voltage of the neutral point and included in the predetermined frequency band, based on a value of a current flowing from the neutral point to the motor being less than a predetermined reference current value.
